(19) United States
(12) Patent Application Publication
(10) Pub. No.: US 2017/0161787 A1
(43) Pub. Date: Jun. 8, 2017

(54) SYSTEM AND METHOD FOR PAYMENT WITH A MOBILE WALLET

(71) Applicant: Denizbank Anonim Sirketi, Istanbul (TR)

(72) Inventor: Gurhan CAM, Istanbul (TR)

(73) Assignee: Denizbank Anonim Sirketi, Istanbul (TR)

(21) Appl. No.: 15/325,424

(22) PCT Filed: Jul. 9, 2015
(86) PCT No.: PCT/TR2015/050027

§ 371 Date: Jan. 10, 2017

(30) Foreign Application Priority Data
Jul. 10, 2014 (TR) 2014/08103

(51) Int. Cl. G06Q 30/02; G06Q 20/36

(52) U.S. Cl. CPC G06Q 30/0267; G06Q 20/3674

(57) ABSTRACT

The present invention relates to a mobile payment system and method, which enable mobile device users to receive campaign-special offer information at member merchants and to make payment without touching their mobile devices. The mobile payment method comprises the steps of detecting presence of a beacon device by means of the control unit, transmitting a message, which will be defined via the content management system of the beacon, to the mobile device of the user, upon the message coming to the transmission unit of the mobile device, transmitting the information that the mobile device detected the beacon device to the beacon servers and Intertech, listing the users at the member merchants in a personnel interface, merchant's personnel confirming ID of the customer by asking her/him a personal question, confirming payment procedures of the customer selected from the list, transmitting the payment information to the user.

### CROSS REFERENCE TO RELATED APPLICATIONS

This application is the national phase entry of International Application No. PCT/TR2015/050027, filed on Jul. 9, 2015, which is based upon and claims priority to Turkish Patent Application No. TR2014/08103, filed on Jul. 10, 2014, the entire contents of which are incorporated herein by reference.

### TECHNICAL FIELD

The present invention relates to a mobile payment system and method which enable users to receive local notification preferably for information-advertisement purposes at member merchants where transmitters are installed and to make payment via a mobile application that can be installed in smart phones.

### BACKGROUND OF THE INVENTION

Today, some mobile applications send notifications to the users via beacon technology, but the content of these notifications are limited with campaign notification and they do not provide the opportunity to make payment. Beacon technology is a new technology, which is currently not widespread, and whose main area of use is to send campaign/special offer notifications to the customers. The special offers sent to the mobile smart phones via this technology are displayed during payment, but the current payment systems are used. This causes Beacon technology to be functionless during payment.

In order for the Beacon technology to be operated, one transmitter should be installed within the shop; and the devices that will receive information from this transmitter should support iBeacon technology.

United States patent document no. US20110300802 A1, an application known in the state of the art, discloses a method which facilitates sharing information and shopping (commercial transaction) between two wireless devices located close to each other. For example, a transmitter installed in a supermarket can send advertisement and discount information to the mobile devices of the customers and the customer can make payment via their smart phones. The purchase and sale transaction in the method comprises many steps and processes requiring confirmation.

International patent document no. WO2002099758 A1, an application known in the state of the art, discloses an automated payment system. The system comprises at least one wireless message transmitter (beacon) and at least one wireless message receiver (e.g. mobile smart phones), and in a preferred embodiment of the system, the data transfer between these devices is performed via Bluetooth. The customer can purchase the product s/he likes by using her/his mobile device, and for this, s/he should hold her/his mobile device under the transmitter for a few seconds.

United States patent document no. US2014058870 A1, an application known in the state of the art, discloses a customer/merchant lock system that facilitates shopping. In the system, the customer creates a user profile by using her/his mobile device and can save any desired information such as personal information, payment details, preferred payment methods, etc. In order to make the payment, the customer should send a purchase command to the receiver of the merchant by using her/his phone.

### SUMMARY OF THE INVENTION

The objective of the present invention is to provide a mobile payment system and method which enable smart mobile device users to receive campaign-special offer information when they enter a member merchant shop and to make payment without touching their smart phones.

### BRIEF DESCRIPTION OF THE DRAWINGS

A mobile payment method developed to fulfill the objectives of the present invention is illustrated in the accompanying figure in which:

FIG. 1 shows the steps of the mobile payment method.

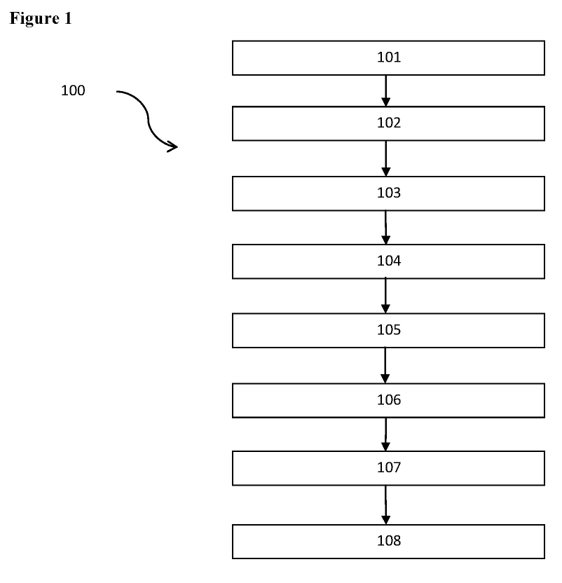

The components in the figure are given reference numbers as follows:
1. Mobile payment system
2. Transmission unit
3. Beacon
4. Control unit
5. Storage unit
6. Content management unit
7. Interface
100. Mobile payment method
101. Detecting presence of a beacon device by means of the control unit,
102. Transmitting a message, which will be defined via the content management system of the beacon, to the mobile device of the user,
103. Upon the message coming to the operation unit of the smart phone, transmitting the information that the mobile device detected the beacon device to the servers,
104. Listing the users at the member merchants in a personnel interface,
105. When the customer approaches the cashier's desk, the beacon (3) device located near the cash register detecting the customer in “Very close” status,
106. Confirming identity of the customer,

107. Confirming payment procedures of the customer selected from the list,
108. Transmitting the payment information to the user,

### DETAILED DESCRIPTION OF THE INVENTION

A mobile payment system (1), which enables smart phone users to receive campaign-special offer information at member merchants and to make payment without touching their mobile devices, basically comprises
at least one transmission unit (2) which is provided in the smart phone of the user and which enables wireless data reception and transmission,
at least one beacon (3) which is provided at member merchants and which sends data to the transmission unit (2) in the smart phones of the users,
a control unit (4) adapted to detect the member merchant's beacon (3) device triggered by the user location and User ID information received from the transmission unit (2),
at least one storage unit (5) where the user information transmitted to the beacon (3) devices at the member merchants is stored,
a content management unit (6) adapted to select the campaign/notification suitable to the user according to the user information in the storage unit (5),
at least one personnel interface (7) which enables to view the information of the users at the member merchants and to receive payment.

A mobile payment method (100), which enables smart phone users to receive campaign-special offer information at the member merchants and to make payment without touching their mobile devices, basically comprises the steps of
Detecting presence of a beacon (3) at the member merchants by means of the control unit (4) (101),
Transmitting a message, which will be defined via the content management system (6) of the beacon (3) device, to the mobile device of the user (102),
Upon the message coming to the control unit (4) of the smart phone, transmitting the information that the mobile device detected the beacon (3) device to the servers (103),
Listing the users at the member merchants in a personnel interface((7) (104),
When the customer approaches the cashier's desk, the beacon (3) device located near the cash register detecting the customer in “Very close” status (105).
Merchant's personnel confirming ID of the customer by asking her/him a personal question (106),
Confirming payment procedures of the customer selected from the list (107),
Transmitting the payment information to the user (108).

In one embodiment of the invention, the data which are present in the smart phone of the user and which are transmitted to the transmission unit wirelessly are the current location and ID information of the user.

In a preferred embodiment of the invention, transmission of the payment information to the user (107) may be via a sound, warning or signal by means of the smart phone.

In a preferred embodiment of the invention, if the user has previously approved mobile payment processes and her/his daily payment limit is sufficient, payment takes place.

In a preferred embodiment of the invention, fastPay, Palpay or beaconPay can be used for mobile payment processes.

The mobile payment method (100) of the present invention enables to send campaign information to the mobile phones of the users by means of the beacon (3), and also enables the users to make their payment fast thanks to the fact that the member merchant recognizes the users who come to use the campaigns.

The transmission unit (2), which is provided in the smart phones of the users and is used for receiving and sending data, is Bluetooth in one embodiment of the invention. When a beacon (3) device is detected by a control unit (4) of a mobile device, whose Bluetooth is on and in which fastPay is installed (101), a message which will be defined via the content management system (6) of the beacon device (3) is sent to the mobile device of the user by local notification (102). In the preferred embodiment of the invention, this message contains the campaign information.

After the control unit (4) of the mobile device in which FastPay is installed receives this message; when the control unit (4) detects the beacon (3) device at the member merchant (101), this detection information is transmitted to the beacon (3) servers and Intertech (103). The customers present at the merchant shop are listed in an application created specifically for the merchants, that is to say, in the interface (7) of a device used by the personnel (104). When a beacon (3) device, which is preferably positioned close to the cashiers at the member merchant, detects the user, the customers who are closer to the cashier's desk will be at the higher rows in the list. The customer who is closest to the device will be at the topmost part of the list.

When ID information of the users is received, if there is a merchant nearby, the merchant's beacon (3) collects this information, establishes a connection between the merchant and the customer to enable transmission of notifications, and this way, the user's smart phone detects the beacon (3) device.

IP and location information are received at certain time intervals by means of the application in the smart phone of the user. IP information of the merchants is provided at the servers by means of the interface (7) which is an application allocated for the merchants.

In the preferred embodiment of the invention, the servers, to which the information that the smart phone is detected is transmitted (103), may be beacon servers or Intertech.

In the preferred embodiment of the invention, the merchant's personnel can view the interface (7), wherein the users are listed, via the tablet that will be allocated to the member merchants.

When the customer wants to make the payment via BeaconPay at the concerned merchant shop, s/he communicates this request to the personnel and the personnel (preferably looking at the customer at the topmost part of the list) finds the customer from the user list displayed on the interface (7) and can carry out the payment procedures in the field that will be opened after touching the name of the customer in the list.

In another embodiment of the invention, if the customer is close to the member merchant, s/he will appear in the member merchant application. The total amount information is not entered by the personnel, but it is entered automatically into the related field in the personnel interface (7) as a result of automatic calculation of the total transaction amount by the cash register after the barcodes of the products are read by a barcode reader, and this information is confirmed by the personnel.

In another preferred embodiment of the invention, payment process begins when the user goes to the cashier's desk and states that she will make payment via BeaconPay. When the customer is going towards the cashier's desk, closeness of the customer to the beacon (3) device which is, placed next to the cash register is switched to “Very close” status and the list in the merchant displays, i.e. the personnel interface (7), is updated and the user is located at the top rows in the list. The merchant personnel addresses the customer by the name at the topmost part of the list, and asks confirmation of the user preferably by stating the last two digits of the phone number of the user. After the confirmation, the personnel selects the customer on the display and after entering the transaction amount in the field that will appear on the display, pushes the “Continue” button. When the Continue button is pushed, the application carries out transaction continuation by sending a warning message such as “Y liras will be collected from fastPay user X, do you confirm?”, which will include the transaction amount that is entered and the name of the customer, in order to prevent any typographic error.

In standard application, if the user has previously approved beaconPay processes and her/his daily payment limit is sufficient, payment takes place. While the merchant's personnel views in the display that the payment process is completed, the information that the payment is completed is sent to the customer by a push notification via the beacon (3) (108). Push notification infrastructure is sent by the bank; when fastPay payment is made it is viewed in the bank system and the notification is sent to the customer by the bank.

In order to use this method of payment, first of all the user should have a smart phone preferably using Bluetooth 4.0+ version, Bluetooth should be active and the fastPay application should be installed and activated in the mobile device. When the customers, who have met these requirements, approach a merchant where the beacon (3) device is arranged, their mobile phones detect the beacon (3) device and the user is listed in the display of the merchant at the end of the mentioned processes.

Information about closeness of the customer is received by the beacon (3) devices placed at the members merchants. User ID and location information are received at certain periods of time by means of the fastPay application installed in the user's smart phone. These information are combined at the server and this way closeness information is figured out.

In order to perform the mobile payment process, firstly the balance and limits of the user are checked. The control unit in the fastPay application first of all checks the fastPay balance of the user whose transaction is carried out; if the balance is insufficient, checks whether the user has a connected account and checks the balance of the account, and if this is insufficient as well, checks whether the user has a connected credit card. If at least one of the balances is sufficient or even if the balances are insufficient, if the user's credit card is connected to the application, the system checks the payment limit of a BeaconPay account opened previously by the user, and if the remaining payment limit is greater than the transaction amount, the system passes to the next step to carry out the process.

If the user has not previously approved BeaconPay processes, then the transaction is sent for confirmation. This is shown on the merchant's display with the warning “The transaction is sent for confirmation of the customer”, and a push notification is sent to the customer to inform her/him that confirmation is required for the transaction. When the user touches this notification, a screen of the application which normally cannot be accessed is opened without asking for any password. The user can view the information about the transaction in this screen and if s/he wishes, confirms the transaction to proceed with the payment. When confirmation is sent, the customer is provided with the information that the payment is made again via a push notification.

In the merchant's display, the warning “The transaction is sent for confirmation of the customer” disappears from the screen and is replaced by another warning stating that payment is collected.

What is claimed is:

1. A mobile payment system, which enables a smart phone user to receive campaign-special offer information at a member merchant and to make payment without touching the smart phone, comprising:
a transmission unit which is provided in a mobile device of a user and which enables wireless data reception and transmission,
a beacon device which is provided at the member merchant and which sends data to the transmission unit in the mobile device of the user,
a control unit adapted to detect the beacon device at the member merchant triggered by a location and User ID information received from the transmission unit,
a storage unit where the user information transmitted to the beacon device at the member merchant is stored,
a content management unit adapted to select a campaign/notification suitable to the user according to user data in the storage unit,
a personnel interface which enables to view information of the user at the member merchant and to receive payment.

2. The mobile payment system according to claim 1, wherein the transmission unit which is Bluetooth used for sending and receiving data in the smart phone of the user.

3. A mobile payment method, which enables a mobile device user to receive campaign-special offer information at a member merchant and to make payment without touching a mobile device, comprising:
detecting presence of a beacon device by means of control unit,
transmitting a message, which will be defined via a content management system of the beacon device, to the mobile device of a user,
transmitting the information that the mobile device detected the beacon device to a plurality of beacon servers and Intertech, upon the message coming to a transmission unit of the mobile device,
listing the user at the member merchant in a personnel interface,
detecting a customer in a “very close” status by the beacon device located near a cash register, when the customer approaches a desk of a cashier,
confirming ID of the customer by a personnel of the member merchant by asking the customer a personal question,
confirming a plurality of payment procedures of the customer selected from a list,
transmitting payment information to the user.

4. The mobile payment method according to claim 3, wherein campaign information is sent to the mobile device of the user in the step of “transmitting a message, which will be defined via a content management system of the beacon device, to the mobile device of a user (102)”.

5. The mobile payment method according to claim 3, wherein in the step of “listing the user at the member merchant in a personnel interface”, when the beacon device, which is positioned close to the cashier at the member merchant, detects the user, the customer who is closer to the desk of the cashier will be at a top row in the list.

6. The mobile payment method according to claim 5, wherein in the step of “listing the user at the member merchant in a personnel interface”, the customer who is closest to the beacon device, which is positioned close to the cashier at the member merchant, will be at a topmost part of the list.

7. The mobile payment method according to claim 3, wherein in the step of “confirming a plurality of payment procedures of the customer selected from a list”, a total transaction amount is automatically entered into a related field in the personnel interface as a result of automatic calculation of the total transaction amount by the cash register after a plurality of barcodes of products are read by a barcode reader.

8. The mobile payment method according to claim 3, wherein in the step of “confirming a plurality of payment procedures of the customer selected from a list”, a transaction confirmation is carried out in order to prevent any typographic error by sending a warning message such as “Y liras will be collected from fastPay user X, do you confirm?”, which will include the transaction amount that is entered and a name of the customer.

9. The mobile payment method according to claim 8, wherein in the step of “confirming a plurality of payment procedures of the customer selected from a list”, a balance and limits are checked by a warning message after the transaction confirmation.
